(19) United States
(12) Patent Application Publication
(10) Pub. No.: US 2024/0180128 A1
(43) Pub. Date: Jun. 6, 2024

(54) FLOATING STRUCTURE FOR INSTALLATION IN WATER, A CLOSED RING-STRUCTURE AND A TUBULAR ELEMENT FOR BUILDING A FLOATING STRUCTURE, AND A METHOD FOR BUILDING A VERTICAL STRUCTURE

(71) Applicant: AQUAFLOAT, Oslo (NO)

(72) Inventor: Finn SANDMÆL, Asker (NO)

(21) Appl. No.: 18/571,509

(22) PCT Filed: Jun. 16, 2022
(86) PCT No.: PCT/NO2022/050136

§ 371 Date: Dec. 18, 2023

(30) Foreign Application Priority Data
Jun. 16, 2021 (NO) 20210777

(51) Int. Cl. A01K 61/60; B63B 75/00

(52) U.S. Cl. CPC A01K 61/60; B63B 75/00

(57) ABSTRACT

The invention relates to a floating structure (100), a closed ring-structure (200) and a tubular element (300) for building a floating structure (100), a central structure (400), and to a method for building a vertical structure (102). The floating structure (100) comprises:—a plurality of tubular elements (300) connected with joints (220) at the ends of adjacent tubular elements (300) to form a plurality of stackable, closed ring-structures (200) and wherein said closed ring-structures (200) are provided with a vertical attachment means (332, 342) binding adjacent, stacked, closed ring-structures (200) together vertically to form a vertical structure (102) with an internal volume (101) intended for filling with water and other objects such as fish,—the closed ring-structures (200) being provided with buoyancy chambers—the vertical structure (102), when assembled, adapted for filling with a concrete filling within its interior,—a bottom structure (110) covering a bottom end of the vertical structure (102). The method for building a vertical structure (102) using a plurality of tubular elements according to any of the preceding claims, comprising:—assembling tubular elements (300) by joining ends of adjacent tubular elements to form a first closed ring-structure (200) intended to be mounted on top of a preceding structure (110, 200),—filling the tubular spacing (311) of the tubular elements (300) of said first closed ring-structure (200) with a concrete filling, and—repeating the previous steps.

### FIELD OF THE INVENTION

The present invention relates to a floating structure for installation in water, that may be used for example as a net cage for fish farming and to a method for building such floating structure. The invention also relates to a closed ring structure and a tubular element to be used when building such floating structure, and to a central structure for a floating structure that may provide various functions for the floating structure.

### BACKGROUND OF THE INVENTION

Closed system aquaculture, such as closed fish cages, provides a controlled interface between the fish and the natural environment and is used to avoid fish escaping the farm and to prevent parasites, such as sea lice and other harmful organisms from entering the cages. Use of chemicals for delousing can be reduced or even eliminated when farming fish in closed systems. Closed system aquaculture also allows for controlling waste and reduced contamination, thus making it possible to collect remnants from feed or excrement.

State of the art is reflected in traditional fish pens which are built as large structures and towed into place and anchored into position. These are large, heavy and rather unwieldy. Building onshore requires transportation and moving of large and heavy structures. The processes of building and installing are also expensive.

Closed fish cages can be made flexible, semi-flexible or rigid. The flexible tanks are typically made by tarpaulin suspended from a floating collar, while rigid tanks are made in steel. Rigid tanks may provide increased robustness in terms of reducing the risk of escape of fish and contaminants, and in terms of tolerating severe environmental loads. Rigid tanks are expensive to build and has a complex building process. Transportation and assembly of the large structure is also complex and costly.

From prior art one should refer to JP2010104237 which relates to a floatable and sinkable fish-breeding reef of organic material, ES 2578429 A1 which relates to an offshore floating aquaculture device for the cultivation of various fish species, and JP S55114575 U which relates to a frame body for reefs constituting artificial fish reefs.

There is therefore a need for a method and a system to overcome the above-mentioned problems.

### Objects of the Present Invention

It is an object of the invention to provide a floating structure especially suitable for use as a fish pen, with a time and cost-efficient building process. It is an object that the floating structure is a closed tank, i.e., that the internal volume of the tank is separated and closed from the outside environment, typically the sea, except for any intended and controlled supply or removal, such as water exchange or removal of waste. Further it is an object to provide for a simpler assembly process, requiring less labour and also to reduce complexity in building the structure and setting it afloat.

It is an object of the invention to provide a floating construction designed for building a major part of the structure on water. A further object is to provide a fish pen comprising modules or elements that can be pre-fabricated and transported to a ship-yard or similar for assembly and setting it afloat.

It is also an object to provide a tank suitable to be used as a fish pen that is robust and rigid.

It is an object to provide a floating construction with improved resistance to wear and degradation in marine environment, thus having improved lifetime.

### SUMMARY OF THE INVENTION

The objective is achieved according to the invention by a floating structure, a closed ring-structure, a tubular element, and a central structure as defined in claim 1, 8, 9, and 15, respectively, and to a method for building a vertical structure as defined in claim 18.

A number of non-exhaustive embodiments, variants or alternatives of the invention are defined by the dependent claims.

### DESCRIPTION OF THE DIAGRAMS

Embodiments of the present invention will now be described, by way of example only, with reference to the following diagrams wherein:

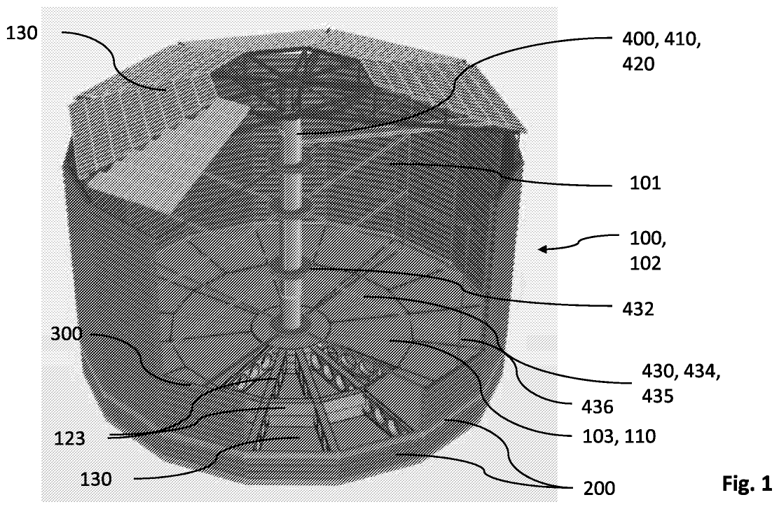

FIG. 1 shows an embodiment of a floating structure according to the invention in perspective view,

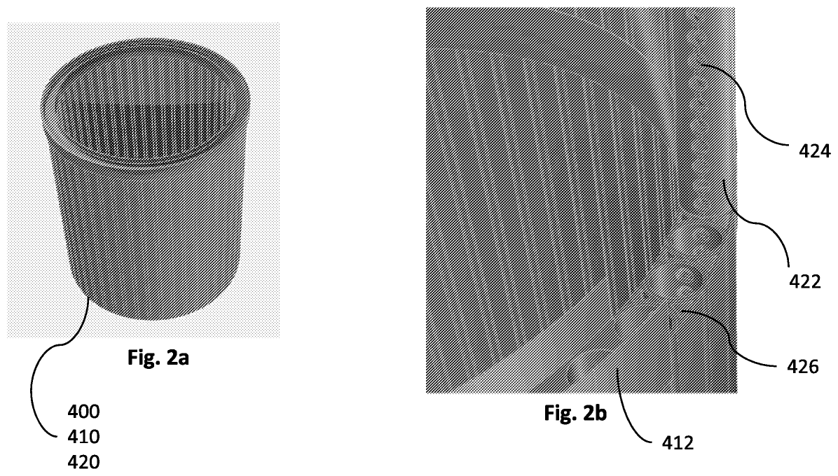

FIGS. 2a and 2b shows an embodiment of a central structure in perspective view and in detail view respectively,

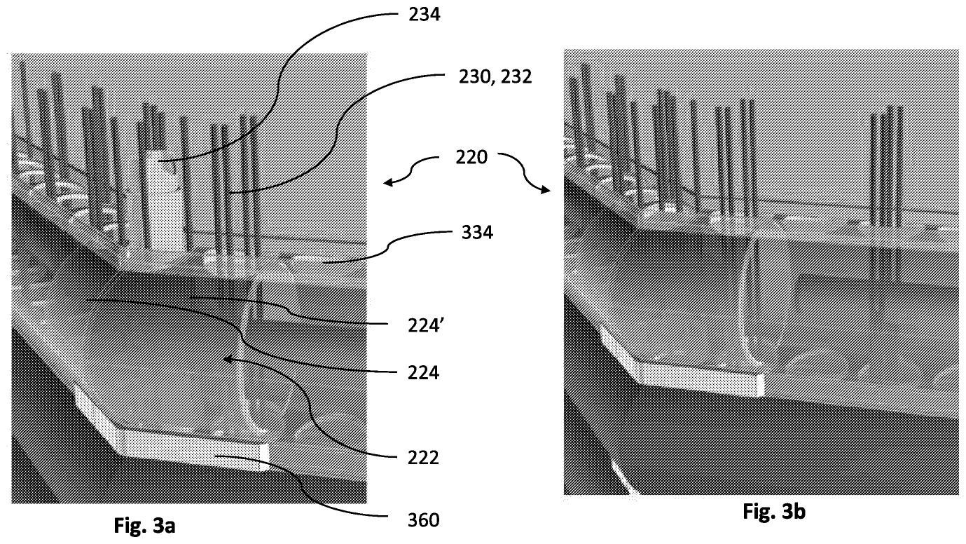

FIGS. 3a and 3b show an embodiment of a joint between two tubular elements with and without a vertical pipe,

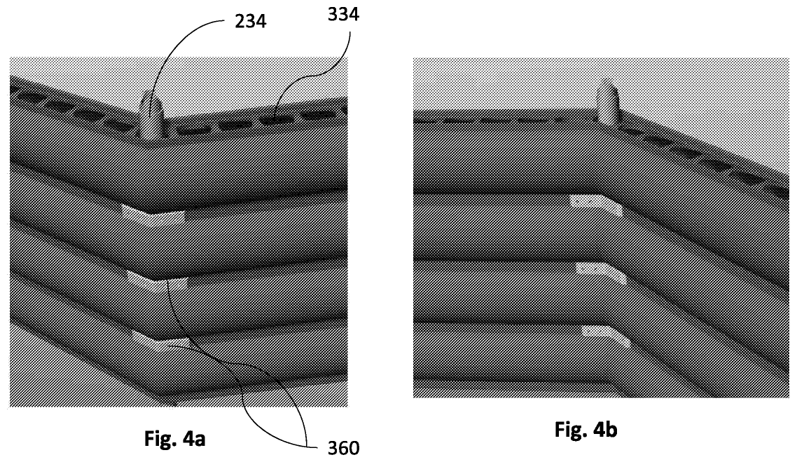

FIGS. 4a and 4b show an embodiment of a joint between two tubular elements with a vertical pipe and fastening brackets seen from the outside and the inside of the floating structure, respectively,

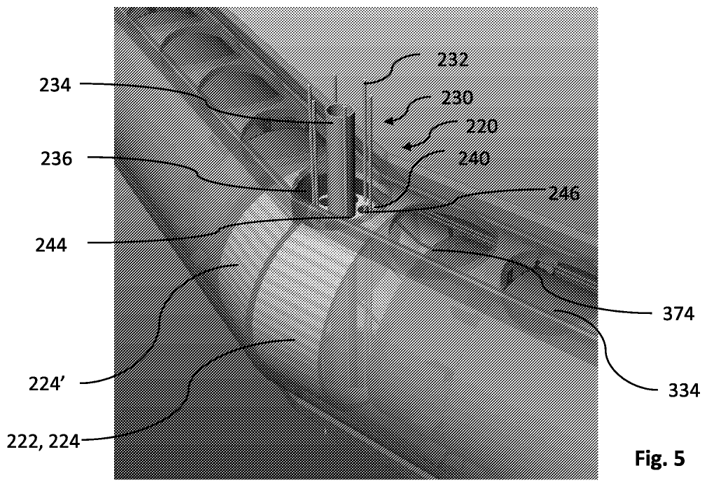

FIG. 5 shows an embodiment of a joint between two tubular elements and a vertical reinforcement structure,

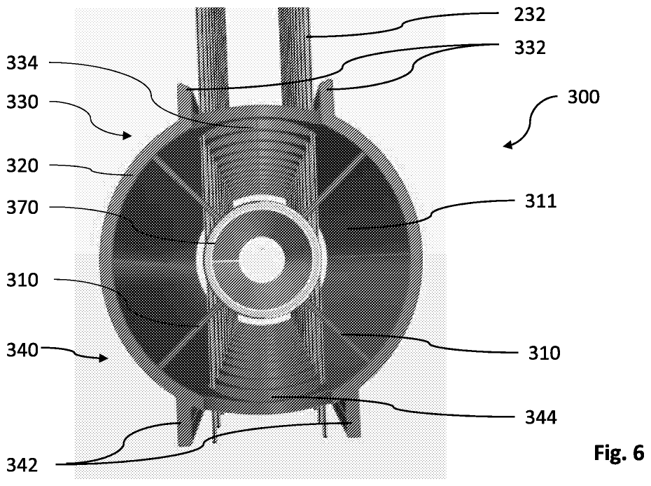

FIG. 6 shows a cross section through an embodiment of a tubular element,

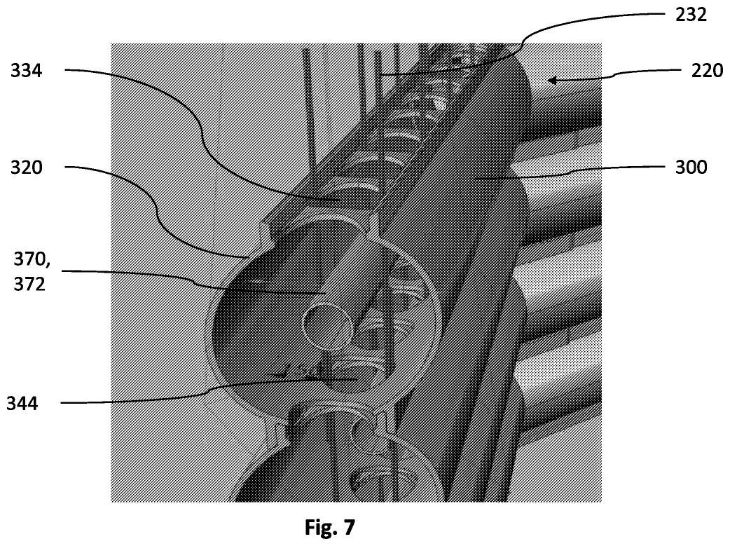

FIG. 7 shows a cross section through a mid-section of stacked tubular elements,

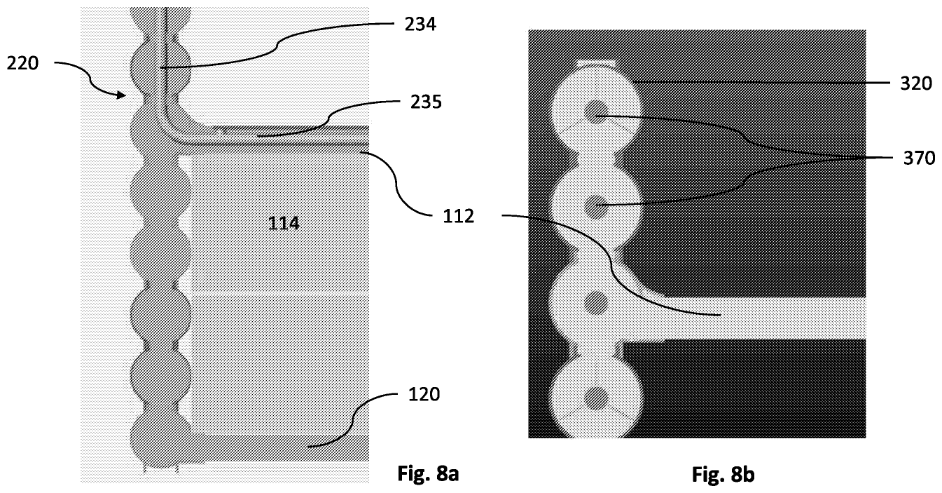

FIGS. 8a and 8b show a cross section through an embodiment of a wall structure of the floating structure, the cross section taken vertically through the joints and through a mid-section along the tubular elements, respectively,

FIG. 9 shows an embodiment of two stacked outer tubes, wherein the lower outer tube comprises a side attachment means,

FIG. 10 shows an embodiment of a tubular element comprising a side attachment means,

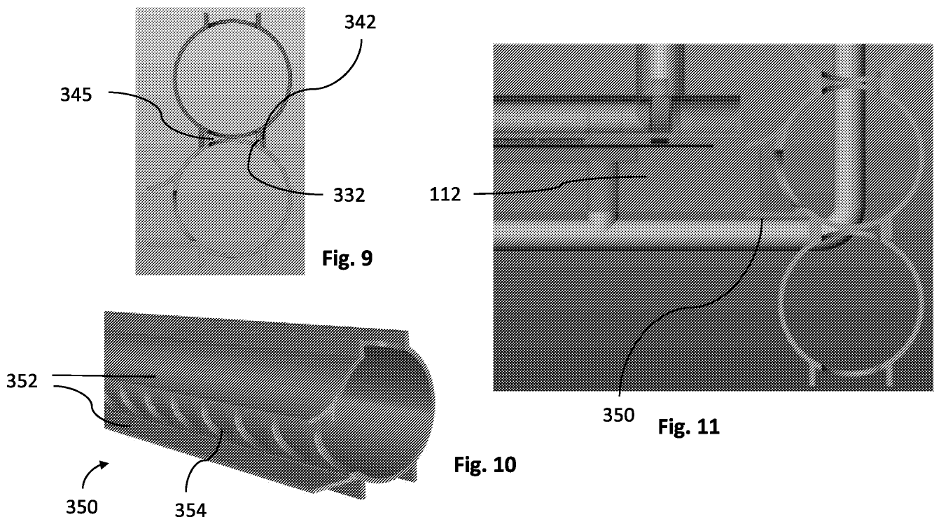

FIG. 11 shows a cross section through an embodiment of a lower part of a floating structure wherein a tubular element is connected via side attachment means to a floor element,

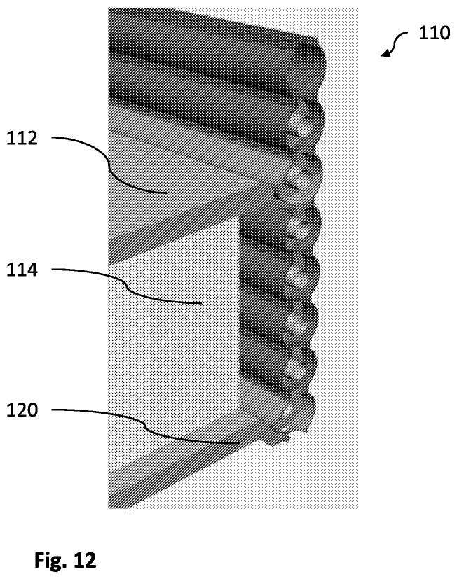

FIG. 12 shows a cross section of a part of an embodiment of a bottom structure comprising an upper flooring and a lower flooring with float elements between.

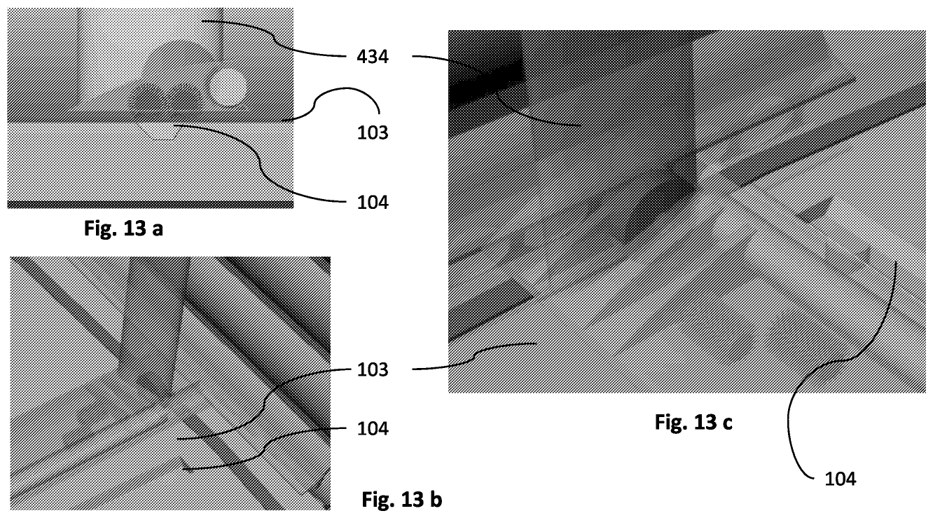

FIGS. 13a, b, c shows from various perspectives an embodiment of the bottom of the inside of the floating structure comprising a horizontal wing with cleaning means.

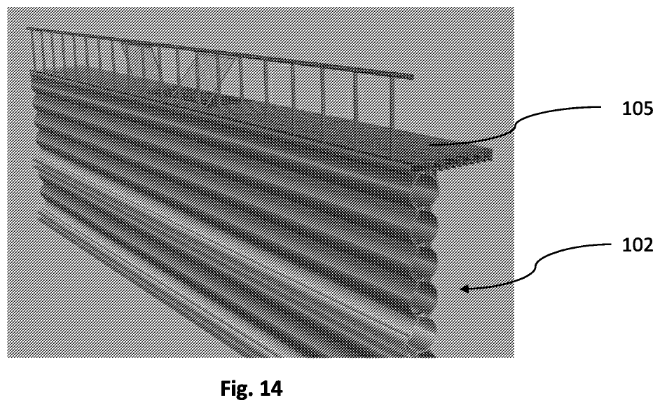

FIG. 14 shows an embodiment of a section of an upper part of a floating structure according to the invention comprising a walkway.

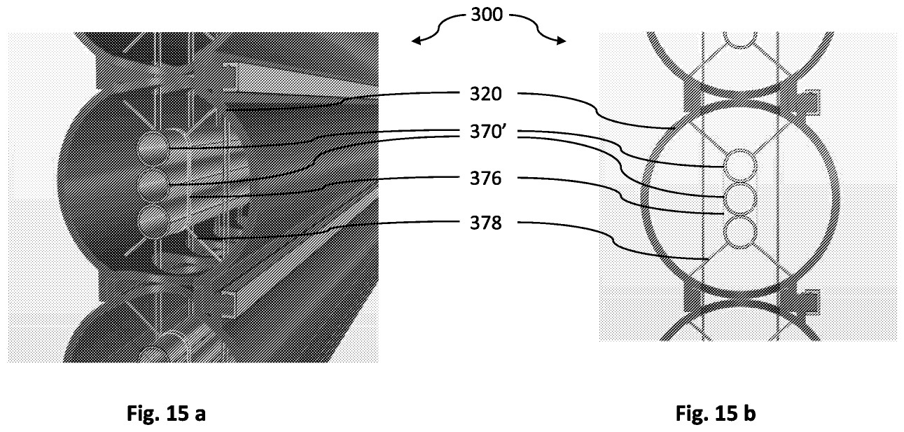

FIGS. 15a and 15b show a cross section of an embodiment of a tubular element in perspective and end on, respectively.

Description of the Reference Signs
The following reference numbers and signs refer to the drawings:

| | |
|---|---|
| 100 | The floating structure |
| 101 | Internal tank volume of the floating structure |
| 102 | Vertical wall structure |
| 103 | Inner bottom surface of tank |
| 104 | Slots in bottom surface 103 |
| 105 | Walkway |
| 110 | Bottom structure |
| 112 | Upper flooring |
| 114 | Float elements |
| 120 | Lower flooring |
| 123 | Bulkheads or partition walls |
| 130 | Roof structure |
| 200 | Stackable, closed ring-structure |
| 220 | Joint |
| 222 | Connector |
| 224, 224′ | First connector, second connector |
| 230 | Vertical structure |
| 232 | Vertical rebar |
| 234 | Vertical pipe |
| 236 | Volume for concrete |
| 240 | Plate |
| 242 | Opening in plate for vertical rebar |
| 244 | Opening in plate for vertical pipe |
| 246 | Opening in plate for concrete pour |
| 300 | Tubular element |
| 310 | Spacing elements |
| 311 | Tubular spacing |
| 320 | Outer tube |
| 330 | Outer tube upper part |
| 332 | Outer tube upper connector |
| 334 | Outer tube upper openings |
| 340 | Outer tube lower part |
| 342 | Outer tube lower connector |
| 344 | Outer tube lower openings |
| 345 | Channel inside connectors 332, 342 |
| 350 | Outer tube side part |
| 352 | Outer tube side connector |
| 354 | Outer tube side openings |
| 360 | Fastening bracket |
| 370 | Inner tube |
| 370' | One of a plurality of inner tubes |
| 372 | Outer surface of inner tube |
| 374 | Endcap for inner tube |
| 376 | Bundle element |
| 368 | Bundle spacing elements |
| 400 | Central structure |
| 410 | Vertical tube structure |
| 412 | Attachment between sections of vertical tube structures |
| 420 | Section of vertical tube structure |
| 422 | Vertical tube |
| 424 | Opening to adjacent vertical tube |
| 426 | Triangular wall elements |
| 430 | Horizontal wing |
| 432 | Horizontal wing attachment to central structure |
| 434 | Horizontal wing body |
| 435 | Horizontal wing arm |
| 436 | Nozzle |

### DESCRIPTION OF PREFERRED EMBODIMENTS OF THE INVENTION

FIG. 1 shows an embodiment of a floating structure 100 according to the invention in perspective view, wherein parts of the structure are hidden to show the inside of the structure 100. The floating structure 100 comprises a plurality of tubular elements 300 connected with joints 220 (ref. FIG. 3a, 3b) at the ends of adjacent tubular elements 300 to form a number of stackable, closed ring structures 200. The closed ring-structures 200 are provided with vertical attachment means 332, 342 (ref. FIG. 6) binding adjacent, stacked, closed ring structures 200 together vertically to form a vertical wall structure 102, i.e. a wall structure of a tank, with an internal tank volume 101 intended for filling with water and other objects such as fish. The wall structure 102, i.e. the stacked closed ring-structures 200, may further be provided with vertical reinforcement structures 230 providing additional strength to the wall structure. The stack of closed ring-structures 200 may be provided with triangular wall elements 426 for providing a smooth or uniform inner wall surface and/or outer wall surface. An embodiment of such triangular wall elements 426 is disclosed in FIG. 2b, in relation to a central vertical structure 400, but are also suitable for the wall of stacked closed ring-structures 200. The closed ring-structures 200 are further provided with buoyancy chambers, which may be chambers in the tubular elements 300 forming the closed ring-structures 200. The buoyancy chambers may be connected to a water supply or other fluid supply for filling the chambers to be used for ballasting with water or other ballasting fluids.

The vertical wall structure 102 is adapted for filling with a concrete filling within its interior, i.e. the interior of the wall, for providing strength to the floating structure 100, and also allow it to float stably in water. The floating structure 100 further comprises a bottom structure 110 covering a lower end of the vertical wall structure 102 such that the vertical wall structure 102 together with the bottom structure 110 creates a container or tank that may be open or closed at the top, and that may be filled with water, seawater, fish etc., separated from the environment on the outside of the floating structure 100.

Preferably the floating structure 100 is provided with a central structure 400 (see also FIGS. 2a and 2b), which also may be referred to as a central tower, and that comprises a central vertical tube structure 410, and that may be supported by the bottom structure 110. The floating structure 100 may also comprise a roof structure 130 and that may be supported by the wall structure 102 and/or the central structure 400.

The floating structure 100 preferably comprises means for water exchange, i.e. for supply of fresh water or seawater into the internal tank volume 101, and for removal of water from the tank. A pump and/or suction device may be used to draw water and particles out from the internal volume 101 of the floating structure 100.

FIGS. 2a and 2b shows an embodiment of a central structure 400. This can provide mechanical strength, especially for a roof structure 130, a stairwell to access the machinery and supplies located in the bottom structure 110 and also a lift for hauling heavier items.

The central vertical tube structure 410 can be made in a similar way as the walls of the floating structure 110. In one embodiment a central vertical tube structure 410 is formed by assembling a plurality of vertical tubes 422 attached to each other directly or by using triangular wall elements 426. These are formed into a cylinder wall enclosing a cylindrical volume. The vertical tubes 422 may be provided with openings 424 to adjacent vertical tubes. These openings and/or the triangular wall elements provide mutual attachment and rigidity.

For convenience the vertical tube structure 410 can be monolithic or an assembly of sections 420 of vertical tube structures attached at the cylindrical openings using an attachment 412 between sections of vertical tube structures.

In a preferred embodiment the vertical tube structure 410 of the central structure 400 is provided with at least one horizontal wing 430 (ref. FIG. 1), preferably two or more horizontal wings 430, such as two or four horizontal wings 430. Each horizontal wing 430 extends substantially radially from the attachment 432 to the vertical tube structure and comprises a horizontal wing body 434. The horizontal wing body extends preferably close to the wall of the floating structure and/or close to the bottom surface 103 and preferably comprises multiple horizontal wing arms 435 at different heights of the horizontal wing 430. Each horizontal wing 430 is provided with at least one nozzle 436 for aerating or oxygenating water, providing feed or recycling water within the floating structure 100 to a cleaning plant. In some embodiments, pellets are ejected from horizontal wing nozzles 436 close to the surface of the floating structure 100, i.e. from a horizontal wing arm 435 located in the upper part of the horizontal wing 430 close to the surface of the floating structure 100, while aeration is provided from horizontal wing nozzles close to the bottom of the floating structure, i.e. from a horizontal wing arm 435 located close to the bottom surface 103. In some embodiments at least parts of the central structure 400 are rotatable in order for the horizontal wings to move through the body of water enclosed by the floating structure 100. Rotational speed is preferably slow, such as for example 1 meter per minute at the outer part of the horizontal wing 430, close to the inside of the wall 102. The horizontal wing 430 may be provided with brushes or the like at the bottom of the horizontal wing body 434 for sweeping or cleaning the bottom surface 103 of the inside of the floating structure 100 and said bottom surface 103 may be provided with slots 104 wherein the dirt may be collected. Preferably such slots 104 are connected to a suction means out of the slots, for example connected to a pipe located in the bottom structure 110 further connected to a suction means. This is illustrated in FIG. 13a, b, c.

FIGS. 3a and 3b show detail views of a joint 220 between two adjacent tubular elements 300 of a closed ring structure 200 and FIGS. 4a and 4b show an embodiment of a joint between two tubular elements with a vertical pipe and fastening brackets seen from the outside and the inside of the floating structure, respectively. An embodiment of a joint between two tubular elements with a vertical reinforcement structure is seen in FIG. 5.

The closed ring-structure 200 comprises a plurality of tubular elements 300, preferably straight sections of tubular elements 300, connected at each end with joints 220, into a closed ring-structure of polygonal shape. This has the advantage that the tubular elements can be easily produced and also simplifies the concrete pouring and solidification process. In one embodiment, each closed ring-structure 200 is made up of sixteen straight tubular elements 300 of equal length, wherein the tubular elements 300 preferably has a length of 10 m. The number of tubular elements 300 making up one closed ring-structure 200 and the length of each tubular element 300 may vary, in order to obtain the desired size of the structure and to have tubular elements 300 that may be easily handled, for example to avoid the necessity for a crane for lifting. The joint 220 comprises a horizontal attachment means for attaching the two adjoining end parts of the tubular elements 300 forming the joint 220. The horizontal attachment means may comprise a connector 222 which may be an insert bend for inserting into each of the tubular elements' 300 end parts making up a joint 220. The upper and lower connectors 332, 342 may be designed to allow horizontal sliding movement of the tubular element 300 relative to the tubular element directly above or below, such that the connector 222 may be inserted into one end part of a stacked tubular element 300, and the adjacent tubular element 300 may be stacked adjacent via the connectors 332, 342 and then skidded sideways for receiving the connector 222 into the outer tube 320. In another embodiment the horizontal attachment means may comprise a first connector 224 arranged at an end of one of the tubular elements 300 of the joint 220, and a second connector 224′ arranged at an end of the other tubular element 300 of the joint 220. The first and second connectors 224, 224′ may then be fixed together by a tongue and groove joint, welding, gluing or other suitable fastening means. The connector 222 or connectors 224, 224′ may be glued to the inner wall of the end part of the outer tube 320 or may be fastened by the concrete filling. Vertical attachment means in the form of longitudinal tracks on each side of openings 334, 344 are provided for connection with a vertically adjacent closed ring-structure 200 such that a wall structure 102 of the floating structure 100 can be formed.

FIGS. 3a and 3b also show an embodiment of vertical reinforcement structures 230 comprising vertical rebars 232 made of a high-strength material such as steel or basalt fibre. Such rebars 232 may be arranged vertically through the openings 334, 344 on opposite sides of the inner tube 370, as also illustrated in FIGS. 6 and 7. At the joints 220, the rebars 232 may be arranged in a plate 240 with holes for positioning, as illustrated in FIG. 5. The rebars 232 extend as a minimum through the height of one tubular element 300 and at least partly into the tubular element 300 directly below and/or above. Preferably, the rebars 232 extend at least partly into three adjacent stacked tubular elements 300. Preferably, the rebars 232 overlap vertically. In addition to providing the desired strength of the wall structure, this also has the advantage that the rebars 232 can be easily arranged in place during building and concrete filling, since it allows for arranging the rebars 232 while the concrete filling in the lower of the three tubular elements 300 has not yet solidified. The figures also show a fastening bracket 360. In FIG. 3a, a vertical pipe 234 is provided in the joint 220. This pipe 234 extends vertically through the joints 220 of the wall structure 102, and may be used for various purposes, amongst others it may be connected to a suction pipe for suction of dirt out of the tank. Such pipe 234 may be provided in some or all of the joints 220 along the circumference of the wall structure 102, preferably every other joint 220. It may also be used for inflow of air for example. The concrete filling will also fill the vertical space surrounding the vertical reinforcement structure.

FIG. 6 shows a cross section of an embodiment of a tubular element 300 for use as a structural element in a floating structure 100, seen in perspective, and FIG. 7 shows a cross section through a mid-section of stacked tubular elements in perspective view, showing the interior of the tubular elements 300. The tubular elements 300 will be formed into closed ring-structures 200 and will be stacked vertically to form a polygonal wall structure, forming the walls of a tank or container.

The tubular element 300 comprises an inner tube 370 and an outer tube 320 surrounding the inner tube 370, such that a tubular spacing 311 is created between the outside of the inner tube 370 and the inside of the outer tube 320. The inner and/or outer tube is preferably made from a plastic material, such as PVC, which is suitable for the marine environment and for filling with concrete. The relation between the diameters of the inner tube and the outer tube depends on the requirement for buoyancy and for concrete in the wall structure 102, which may be different for example depending on the total size of the floating structure, and the figures therefore illustrate a variation in this relationship. Spacing elements 310 can be used to position the inner tube 370 inside the outer tube 320 and preferably at least two spacing elements 310 are provided within a tubular element 300 radially opposite each other. Rebars 312 of a high strength material such as steel or basalt fiber, may be arranged longitudinally in the tubular spacing 311 for providing additional strength to the tubular element 300. The tubular spacing 311 is intended to be filled with a concrete slurry, preferably a reinforced concrete. The concrete filling will provide strength to the vertical structure 102 and weight for stability in the water. The inner tube 370 is closed at the ends and preferably air-filled for buoyancy. Closing means may be an end cap 374 fixed or releasably attached to the inner tube ends. The fact that the concrete is inside the tubular spacing 311 ensures that it is not exposed to the environment outside the outer tube, i.e. not exposed to sea water, and thus there is no risk for degradation of the reinforced concrete, such as for example corrosion of steel reinforcement which is often a problem for reinforced concrete structures exposed to seawater. The outer tube 320 comprises vertical attachment means 332, 342 for attaching to at least one adjacent outer tube 320 for stacking of tubular elements 300, such that the wall structure can be built. The vertical attachment means may be formed by an upper connector 332 and a complementary lower connector 342 as shown in FIG. 6 and in FIG. 7. The upper and lower connectors 332, 342 each may comprise a pair of longitudinal protruding tracks at the outside of the outer tube 320 configured for engaging with a corresponding pair of longitudinal protruding tracks on an adjacent tubular element 300. This engagement may for example be in the form of a groove and tongue joint. The attachment is preferably secured by additional fastening means fixing the two tubular elements together, such as by fastening brackets 360 secured with a bolt or screw through the tracks, or groove and tongue, as shown in FIGS. 3a, 3b and FIG. 4a, 4b. Such brackets 360 may be fastened on the outside and/or on the inside of the wall structure and preferably at each joint 220. When two tubular elements are stacked, the upper connector 332 of the lower tubular element will engage with the lower connector 342 of the upper tubular element, and a channel 345 is formed between them. The channel 345 is preferably fluid tight.

The outer tube 320 further comprises openings 334, 344 preferably arranged on two opposite sides of the outer tube and positioned between the tracks of the upper connector 332 and between the tracks of the lower connector 342, allowing fluid communication between the tubular spacing 311 in one tubular element and a tubular spacing 311 of an adjacent, stacked tubular element 300. Certain of the tubular elements 300 of the floating structure 100, such as the upper most and lower most tubular elements 300 in the stack, can have openings only on one side or the openings on one side may be covered or closed. When concrete is filled into the tubular spacings 311 and out of the openings 334, 344, the concrete will fill the wall structure 102 as illustrated in FIGS. 8a and 8b. FIGS. 8a and 8b shows a cross section through an embodiment of a wall structure 102 of the floating structure 100, the cross section taken vertically through the joints 220 in FIG. 8a, and through a mid-section along the tubular elements 300 in FIG. 8b. The inner tube 370 does not extend all the way to the joint 220, but is shorter than the outer tube 320 of the same tubular element 300, and therefore the concrete fills also the central part of the outer tube 320 at the joint (FIG. 8a), while along the tubular element, the inner tube 370 provides for a closed compartment that may be air-filled, and thus functions as a buoyancy chamber (FIG. 8b). A vertical pipe 234 may extend vertically through at least some of the joints 220 and be connected to a horizontal pipe 235, which may be arranged in the bottom structure 110, as part of the upper flooring 112, or in a compartment between the upper flooring 112 and the lower flooring 120. This horizontal pipe 235 may be provided with suction means from an inside of the tank.

The channel 345 between the connectors 332, 243, also seen in FIG. 9, allows concrete to flow between the tubular spacings 311 of the tubular elements 300, without escaping out of the wall structure. In FIG. 9, the inner tube 370 is not shown.

The tubular element 300 may also comprise at least one side attachment means, i.e. an outer tube side part 350, as shown in FIGS. 10 and 11, arranged on an outer side part of the outer tube 320, as arranged in installed position, for connecting with a side-connecting part, and with openings 354 to permit fluid communication out of the tubular space on the inside of the outer tube 320 of the tubular element 300. The side-connecting part may for example be a floor element, as shown in FIG. 11, wherein the tubular elements 300 of one closed ring-structure 200 are connected to the upper flooring 112, the tubular elements 300 of another closed ring-structure 200, further below, is connected to the lower flooring 120, thus forming a bottom structure 110.

The bottom structure 110 (ref. FIGS. 1 and 12) may comprise an upper flooring 112, preferably of concrete, and a lower flooring 120, preferably also of concrete. The space between the upper flooring 112 and lower flooring 120 is preferably a closed section which may act as a buoyancy section and may be separated into separate compartments 130 by bulkheads or partition walls 123. Preferably, at least some of the compartments 130 are water tight in case of a leak. Each compartment 130 may be used for holding machinery, pipes, or other equipment or may be filled with buoyancy elements 114 in case of a leakage. The upper flooring 112 preferably comprises a smooth surface as it will serve as the bottom surface 103 of the inside of the tank, which may be obtained by a PPU-surface layer. The bottom structure 110 may also comprise means for suction of water and particles out from the internal volume of the floating structure 100, such as pipes connected to a suction device. Such pipes may be arranged within the section between the upper and lower flooring. In one embodiment, the bottom structure 110 with the upper and lower flooring 112, 120 and the section between, builds approximately 3 m in height, while the height of the tank, i.e. from top of the bottom structure 110 to the top of the wall structure builds approximately 20-25 m. The size and depth of the floating structure 100 may be selected depending on the intended use.

The interior of the wall structure, i.e. the tubular spacing 311 of the tubular elements 300, and/or the upper and lower flooring, is filled with or made of concrete, preferably a fiber-reinforced concrete.

FIG. 14 shows an embodiment of a section of an upper part of a floating structure 110 according to the invention comprising a walkway 105.

The floating structure 100 is designed for easy construction. The bottom structure 110 is first built onshore, providing a foundation for building the wall 102 of stacked closed ring-structures 200. The bottom structure 110 with its buoyancy and ballasting capacity can then be arranged in the water. Because the same tubular elements 300 that make up the wall structure 102 of the floating structure 100 can also be used to build the bottom structure 110, the uppermost tubular elements 300 of the bottom structure 110 comprise a vertical attachment means 332, 342 for engaging with a corresponding attachment means 332, 342 on a lower part of the tubular elements 300 to be stacked on top. Tubular elements 300 can be stacked one-by-one on top of the bottom structure 110 and filled with concrete slurry as the closed ring-structure 200 is built, or a complete closed ring-structure (200) may be built onshore and lifted onto the uppermost closed ring-structure of the floating structure for installation. The process is preferably repeated until a sufficient number of closed ring-structures 200 have been stacked and filled with concrete to form the desired height of the wall structure 102. Vertical reinforcement structures, if needed, are arranged vertically through the openings 334, 344 in the tubular elements 300 of the stack. The concrete, which is preferably pre-reinforced with fibre, is poured into the tubular spacings of the tubular elements after each element has been attached to a tubular element of the closed ring-structure directly below.

The central structure 400 may be built simultaneously as the wall structure 102, preferably in sections 420, preferably keeping the height as close to the building height of the wall 102 as possible.

When pouring the concrete slurry into the stacked tubular elements 300, by use of the rotating central structure 400 or another rotatable device, the rotational speed and thus the speed of concrete pouring may be adapted such that the concrete in the tubular elements 300 has not yet solidified when the pouring device has made a complete round.

The central structure 400 may be used as a base for an apparatus for filling concrete, taking advantage of the ability of the central structure, or its parts, to rotate slowly around a central vertical axis of the structure 100.

During construction, the inner space of the inner tube may be air-filled, or at least partly filled with for example water. The inner volume 101 of the floating structure, i.e. the tank volume, may be filled gradually with water as the wall structure 102 is built, for controlling the total buoyancy of the structure 100, such that the floating structure 100 gradually sinks down into the water column in a controlled manner, and only part of the wall structure 102 extends above water level for installing the subsequent closed ring-structure 200. This provides for a very convenient and safe building environment, allowing the workers to always work at the same height. There is no need for additional formwork to build the concrete walls, as the tubular elements 300 provides this feature as well as being part of the final wall structure 102. This significantly enhances the building process, especially in terms need for labor and in terms of time required for building. It will also directly contribute to reduced material costs.

FIGS. 15a and 15b show a cross section of an embodiment of a tubular element in perspective and end on, respectively. This is an alternative to the embodiment shown in FIG. 6, wherein a single inner tube 370 is replaced by a bundle of a plurality of inner tubes 370′. These inner tubes are kept in a bundle by bundle elements 376, and positioned within the outer tube 320 using bundle spacing elements 378. The advantage of using a plurality of inner tubes, is that it is easier to handle several smaller tubes, and that a smaller diameter makes each tube easier to bend when inserting into the outer tube. While the figure shows three inner tubes positioned in-line, one can easily envisage alternatives such as triangular packing and solutions with two or more than three tubes. The bundle elements 376 ensures buoyancy.

1. A floating structure (100), comprising:
a plurality of tubular elements (300) connected with joints (220) at the ends of adjacent tubular elements (300) to form a plurality of stackable, closed ring-structures (200) and wherein said closed ring-structures (200) are provided with a vertical attachment means (332, 342) binding adjacent, stacked, closed ring-structures (200) together vertically to form a vertical structure (102) with an internal volume (101) intended for filling with water and other objects such as fish,
the closed ring-structures (200) being provided with buoyancy chambers,
the vertical structure (102), when assembled, adapted for filling with a concrete filling within its interior,
a bottom structure (110) covering a bottom end of the vertical structure (102).

2. The floating structure according to claim 1, wherein said buoyancy chambers comprise a closed inner tube (370) arranged inside the tubular elements (300) and/or a vertical pipe (234) extending vertically through the wall structure (102) at the joints (220).

3. The floating structure according to claim 1, comprising vertical reinforcement structures (230) arranged vertically through the tubular elements (300) of the closed ring-structures (200) and extending at least partly into two adjacent stacked tubular elements (300).

4. The floating structure according to claim 1, wherein the vertical reinforcement structures (230) comprises rebars (232) arranged in one or more positioning elements.

5. The floating structure according to claim 1, wherein the bottom structure (110) is provided with buoyancy chambers connected to fluid supply for ballasting.

6. The floating structure according to claim 1, wherein the bottom structure comprises
an upper flooring of concrete
a lower flooring of concrete
a buoyancy section between upper and lower flooring comprising buoyancy elements.

7. The floating structure according to claim 1, wherein the bottom structure comprises means for suction of water and particles out from the internal volume of the floating structure.

8. A closed ring-structure (200) for building of a floating structure (100) according to claim 1, wherein the closed ring-structure (200) comprises:
a plurality of tubular elements (300) connected at each end with joints (220),
vertical attachment means (332, 342) for connection with an adjacent closed ring-structure (200) such that a plurality of closed ring-structures (200) can be stacked into a wall structure (102) of the floating structure,
buoyancy chambers, and
at least one void space (311) intended for concrete filling.

9. A tubular element (300) for use as a structural element in a floating structure (100) comprising:
an inner tube (370) closed at each end,
an outer tube (320) surrounding the inner tube (370) such that a tubular spacing (311) is created between the outside of the inner tube (370) and the inside of the outer tube (320) for filling with a concrete filling,
spacing elements (310) positioning the inner tube (370) inside the outer tube (320),
vertical attachment means (332, 342) to at least one adjacent tubular element (300) for stacking of tubular elements
openings (334, 344) in the outer tube (320) wall to permit fluid communication between the tubular space (311) and an outside of the tubular element (300), wherein at least one of the ends of the tubular element (300) is adapted to connect to a horizontal attachment means for connection with an adjacent tubular element end-to end.

10. The tubular element (300) according to claim 9, wherein the inner tube (370) is air-filled for buoyancy.

11. The tubular element (300) according to claim 9, wherein the inner tube (370) is shorter than the outer tube (320) of the same tubular element (300) such that the inner tube (370) does not extend or does only partially extend into the joint (220).

12. The tubular element (300) according to claim 9, wherein the vertical attachment means (332, 342) comprises a pair of longitudinal protruding tracks (332, 342) at the radial outside of the outer tube (320) arranged on each side of the openings (334, 344) and configured for engaging with a corresponding pair of longitudinal protruding tracks on an adjacent tubular element (300).

13. The tubular element (300) according to claim 9, wherein the longitudinal protruding tracks are configured such that when engaged with the corresponding tracks on an adjacent tubular element, the tracks form fluid-tight walls radially outside the openings in the outer tube, thus creating an enclosed volume for concrete filling between the tubular elements (300).

14. The tubular element (300) according to claim 9, further comprising side attachment means arranged on an outer side part (350) of the outer tube (320), as arranged in installed position, for connecting with a side connecting part, and preferably with openings (354) to permit fluid communication out of the tubular space (311) on the inside of the outer tube (320) of the tubular element (300).

15. A central structure (400) for a floating structure (100) according to claim 1, wherein the central structure (400) comprises a vertical tube structure (410).

16. The central structure according to claim 15, wherein the vertical tube structure (410) is composed of a plurality of vertical tubes (422) attached to each other using triangular wall elements (426), forming into a cylinder wall enclosing a cylindrical volume.

17. The central structure according to claim 15, wherein the vertical tube structure is provided with a horizontal wing (430) attached by an attachment (432) to the central structure (400), wherein said horizontal wing is provided with at least one nozzle (436).

18. A method for building a vertical structure (102) using a plurality of tubular elements according to any of the preceding claims, comprising:
assembling tubular elements (300) by joining ends of adjacent tubular elements to form a first closed ring-structure (200) intended to be mounted on top of a preceding structure (110, 200),
filling the tubular spacing (311) of the tubular elements (300) of said first closed ring-structure (200) with a concrete filling, and
repeating the previous steps.

19. The method according to claim 18, wherein the steps filling and stacking take place simultaneously.

20. The method according to claim 18, comprising arranging vertical reinforcement structures (230) vertically through the openings (334) of the tubular elements (300), said reinforcement structures (230) extending at least partly into two adjacent stacked tubular elements (300) while the concrete is solidifying.
